(19) United States
(12) Patent Application Publication
(10) Pub. No.: US 2020/0207096 A1
(43) Pub. Date: Jul. 2, 2020

(54) PRINTER

(71) Applicants: Shunsuke Horie, Kanagawa (JP); Takumi Atake, Kanagawa (JP); Akira Izutani, Osaka (JP)

(72) Inventors: Shunsuke Horie, Kanagawa (JP); Takumi Atake, Kanagawa (JP); Akira Izutani, Osaka (JP)

(21) Appl. No.: 16/722,045

(22) Filed: Dec. 20, 2019

(30) Foreign Application Priority Data
Dec. 28, 2018 (JP) 2018-247074

(51) Int. Cl. B41J 2/165; C09D 11/322

(52) U.S. Cl. CPC B41J 2/16535; C09D 11/322; B41J 2/16552

(57) ABSTRACT

A printer is provided. The printer includes a discharger and a wiper. The discharger has a nozzle surface and contains an ink comprising an organic solvent in an amount of more than 60% by mass of the ink. The discharger is configured to discharge the ink from the nozzle. The wiper is configured to wipe the nozzle surface. The wiper comprises a laminated body including a plurality of layers including a first layer that contacts the nozzle surface. A thickness t1 of the first layer and a total thickness t2 of one or more of the layers other than the first layer satisfy the following relation t1<t2. The first layer has a void ratio smaller than a void ratio of at least one of the layers other than the first layer.

### CROSS-REFERENCE TO RELATED APPLICATIONS

This patent application is based on and claims priority pursuant to 35 U.S.C. § 119(a) to Japanese Patent Application No. 2018-247074, filed on Dec. 28, 2018, in the Japan Patent Office, the entire disclosure of which is hereby incorporated by reference herein.

### BACKGROUND

### Technical Field

The present disclosure relates to a printer.

### Description of the Related Art

Inkjet printers are now widely used at home as an output device of digital signals since they are relatively quiet, enjoy low running costs, and are capable of easily printing color images.

In recent years, inks have been developed for low-absorptive or non-absorptive recording media, such as coated paper and plastic films, as print media in inkjet printing.

However, inkjet printed matter on these low-absorptive or non-absorptive recording media do not undergo penetration drying and ink fixability is poor. In attempting to solve this problem, techniques of incorporating an organic solvent and/or a resin in the ink composition have been proposed.

A liquid discharger, represented by an inkjet printer, needs regular cleaning of its nozzle surface because defective discharge may occur when foreign matters are present on the nozzle surface. In particular, when the ink contains a large amount of resin as described above, foreign matters are likely to be generated on the nozzle surface. One known method for cleaning the nozzle surface involves using sheet-like wipers such as a nonwoven fabric and a woven fabric in combination.

### SUMMARY

In accordance with some embodiments of the present invention, a printer is provided. The printer includes a discharger and a wiper. The discharger has a nozzle surface and contains an ink comprising an organic solvent in an amount of more than 60% by mass of the ink. The discharger is configured to discharge the ink from the nozzle. The wiper is configured to wipe the nozzle surface. The wiper comprises a laminated body including a plurality of layers including a first layer that contacts the nozzle surface. A thickness t1 of the first layer and a total thickness t2 of one or more of the layers other than the first layer satisfy the following relation t1<t2. The first layer has a void ratio smaller than a void ratio of at least one of the layers other than the first layer.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating an image forming apparatus as an example of a printer according to an embodiment of the present invention;

FIG. 2 is a schematic diagram illustrating a nozzle plate to be wiped with a wiper;

FIG. 3 is a schematic diagram illustrating a schematic configuration of a cleaning unit of the image forming apparatus; and

FIG. 4 is a schematic cross-sectional diagram illustrating a sheet-like wiper.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

A cleaning method using the conventional wiper has difficulty in removing fixedly-adhered matter on the nozzle surface resulted from the liquid having been dried. As a result, the number of times of wiping or the wiping pressure is increased and a water-repellent film on the nozzle surface is thereby degraded.

According to some embodiments of the present invention, a printer is provided that is capable of efficiently wiping off a fixedly-adhered ink on a nozzle surface of a discharger with a wiper even when an ink containing a large amount of an organic solvent is used.

A printer according to an embodiment of the present invention includes a discharger having a nozzle surface and containing an ink, configured to discharge the ink from the nozzle, and a wiper configured to wipe the nozzle surface of the discharger, and has the following characteristics.
The ink contains an organic solvent in an amount of more than 60% by mass of the ink.
The wiper comprises a laminated body including a plurality of layers, and each of the layers has voids.
The thickness t1 of the first layer that contacts the nozzle surface and the total thickness t2 of one or more of the layers other than the first layer satisfy the relation t1<t2.
The first layer has a void ratio smaller than that of at least one of the layers other than the first layer.

The printer according to an embodiment of the present invention includes a discharger having a nozzle surface and containing an ink, configured to discharge the ink from the nozzle, and a wiper configured to wipe the nozzle surface of the discharger.

Any known ink discharge head can be used as the discharger. Examples of the discharger include, but are not limited to, a piezo-type inkjet discharge head in which a piezoelectric element as a pressure generator deforms a vibration plate that forms a wall surface of an ink flow channel to vary the inner volume of the ink flow channel to discharge ink droplets; a thermal-type inkjet discharge head in which a heat element heats ink in an ink flow channel to generate bubbles; and an electrostatic-type inkjet discharge head in which a vibration plate that forms a wall surface of an ink flow channel and an electrode are facing each other and an electrostatic force generated between the vibration plate and the electrode deforms the vibration plate to vary the inner volume of the ink flow channel to discharge ink droplets.

In the present disclosure, the ink may be stored in an ink accommodating container such as an ink cartridge.

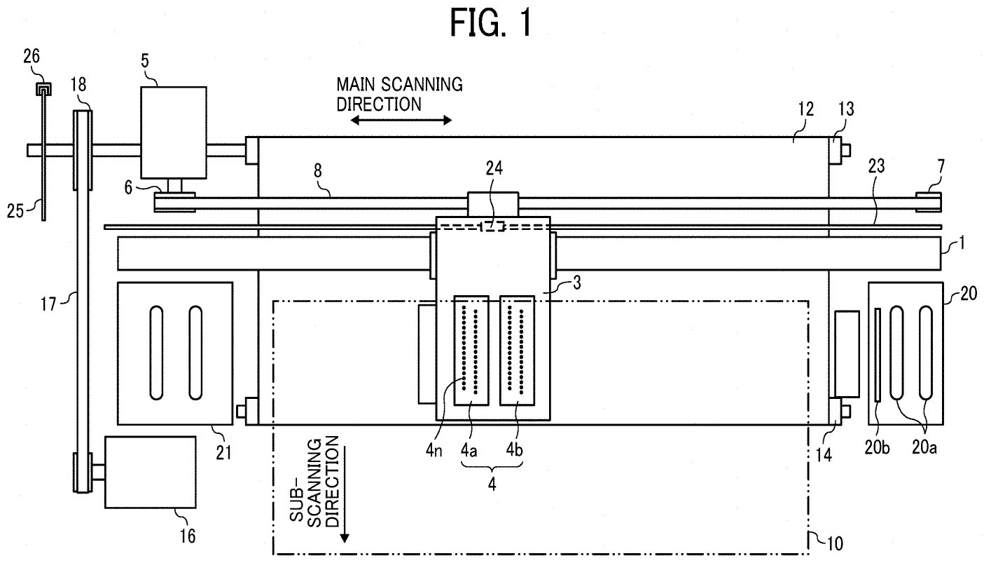

FIG. 1 is a schematic diagram illustrating an image forming apparatus as an example of the printer according to an embodiment of the present invention. This image forming apparatus is equipped with a serial-type droplet discharger. In the image forming apparatus illustrated in FIG. 1, a carriage 3 is movably held by a main guide 1 laterally bridged between left and right side plates and a sub-guide. A main scanning motor 5 reciprocates the carriage 3 in the main scanning direction (carriage moving direction) via a timing belt 8 bridged between a drive pulley 6 and a driven pulley 7.

On the carriage 3, recording heads 4a and 4b (hereinafter each “recording head 4” when not distinguished), each comprising a liquid discharge head, are mounted. The recording head 4 discharges ink droplets of, for example, yellow (Y), cyan (C), magenta (M), or black (K). The recording head 4 has nozzle arrays each comprising a plurality of nozzles 4n, arranged in the sub-scanning direction that is orthogonal to the main scanning direction. The recording head 4 is mounted with its droplet discharging direction downward.

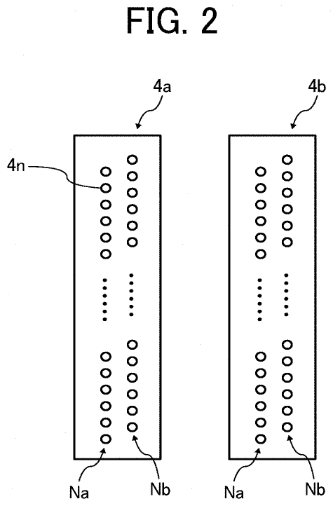

As illustrated in FIG. 2, the recording head 4 has a nozzle surface having two nozzle arrays Na and Nb in each of which a plurality of nozzles 4n are arranged.

Examples of the liquid discharge head constituting the recording head 4 include, but are not limited to, a piezoelectric actuator such as a piezoelectric element, and a thermal actuator that utilizes phase change of a liquid caused by film boiling using an electrothermal conversion element such as a heat element.

The image forming apparatus is further equipped with a conveyance belt 12 that electrostatically attracts a sheet 10 to convey the sheet 10 to a position facing the recording head 4. The conveyance belt 12 is an endless belt stretched between a conveyance roller 13 and a tension roller 14.

The conveyance belt 12 circumferentially moves in the sub-scanning direction as the conveyance roller 13 is rotationally driven by a sub-scanning motor 16 via a timing belt 17 and a timing pulley 18. The conveyance belt 12 is charged by a charging roller while circumferentially moving.

On one side of the carriage 3 in the main scanning direction, a maintenance mechanism 20 for maintaining the recording heads 4 is disposed lateral to the conveyance belt 12. On the other side, a dummy discharge receptacle 21 for receiving dummy discharge from the recording heads 4 is disposed lateral to the conveyance belt 12.

The maintenance mechanism 20 includes a cap 20a for capping the nozzle surface (surface on which the nozzles are formed) of the recording head 4, a nozzle surface wiping mechanism 20b for wiping the nozzle surface, and a dummy discharge receptacle to which liquid droplets not contributing to image formation are discharged.

An encoder scale 23 having a specific pattern thereon is stretched between both side plates along the main scanning direction of the carriage 3. The carriage 3 is provided with an encoder sensor 24 comprising a transmissive photosensor that reads the pattern on the encoder scale 23. The encoder scale 23 and the encoder sensor 24 configure a linear encoder (main scanning encoder) that detects movement of the carriage 3.

A code wheel 25 is mounted on the shaft of the conveyance roller 13, and an encoder sensor 26 comprising a transmissive photosensor that detects a pattern formed on the code wheel 25 is provided thereto. The code wheel 25 and the encoder sensor 26 configure a rotary encoder (sub-scanning encoder) that detects the amount of movement and the position of the conveyance belt 12.

In this image forming apparatus, the sheet 10 is fed from a sheet feeding tray and attracted onto the charged conveyance belt 12. The sheet 10 is then conveyed in the sub-scanning direction by circumferential movement of the conveyance belt 12.

By driving the recording heads 4 in response to an image signal while moving the carriage 3 in the main-scanning direction, ink droplets are discharged onto the sheet 10 not in motion, thus recording one line portion. The sheet 10 is thereafter conveyed for a specified distance and a next line portion is recorded thereon.

In response to a recording end signal or a signal indicating that the rear end of the sheet 10 has reached a recording area, the recording operation is ended and the sheet 10 is ejected onto an output tray.

To clean the recording heads 4, the carriage 3 is moved to the maintenance mechanism 20 during a waiting time for printing (recording), and the cleaning is performed by the maintenance mechanism 20. Alternatively, the cleaning may be performed by moving the maintenance mechanism 20 without moving the recording heads 4.

As illustrated in FIG. 2, the recording head 4 illustrated in FIG. 1 has a nozzle surface having two nozzle arrays Na and Nb in each of which a plurality of nozzles 4n are arranged. The nozzle array Na of the recording head 4a discharges droplets of black (K), and the other nozzle array Nb discharges droplets of cyan (C). The nozzle array Na of the recording head 4b discharges droplets of magenta (M), and the other nozzle array Nb discharges droplets of yellow (Y).

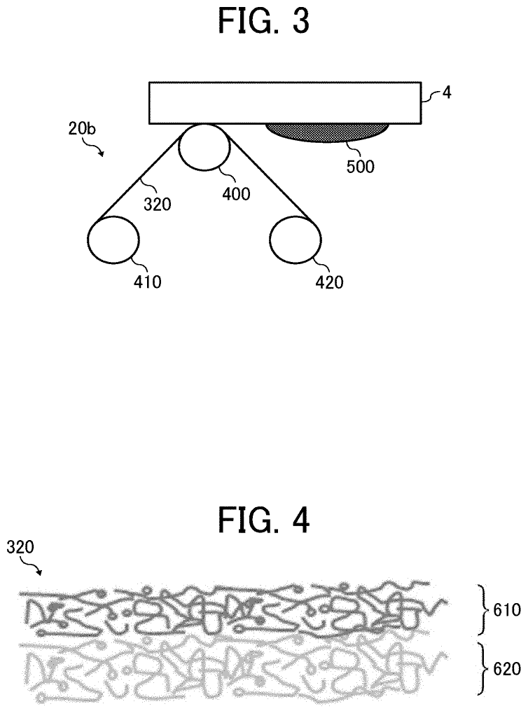

As illustrated in FIG. 3, the nozzle surface wiping mechanism 20b includes a sheet-like wiper 320, a feed roller 410 that feeds out the sheet-like wiper 320, a pressing roller 400 that presses the sheet-like wiper 320 against the nozzle surface, and a winding roller 420 that collects the sheet-like wiper 320 used for wiping. The nozzle surface wiping mechanism 20b may further include a rubber blade or the like for wiping the nozzle surface in addition to the sheet-like wiper 320. The pressing roller 400 can adjust the pressing force by adjusting the distance between the sheet-like wiper 320 and the nozzle surface with a spring. The pressing member is not limited to be in the form of a roller and may be a fixed resin or a rubber member. In a case in which a rubber blade is provided, a mechanism for abutting the rubber blade on the sheet-like wiper 320 may be provided to impart a function of cleaning the rubber blade to the sheet-like wiper 320.

A cleaning fluid may be used for cleaning. In the case of using a cleaning fluid, after a certain amount of the cleaning fluid is applied to the sheet-like wiper 320, the sheet-like wiper 320 is moved relative to the head with the sheet-like wiper 320 pressed against the nozzle surface, so that foreign matter 500 adhered to the nozzle surface is wiped off. Examples of the foreign matter 500 adhered to the nozzle surface include, but are not limited to, mist ink generated when ink is discharged from the nozzle, ink adhering to the nozzle surface when ink is sucked from the nozzle during cleaning, fixedly-adhered ink that is mist ink or ink adhering to the cap having been dried on the nozzle surface, and paper dust generated from print medium. The cleaning fluid may be included in the sheet-like wiper 320 in advance. Alternatively, depending on the sequence, wiping may be performed without applying the cleaning fluid to the sheet-like wiper 320. In a case in which it is assumed that the ink has been dried and fixedly-adhered to the nozzle surface due to a long standby state, it is preferable that the fixedly-adhered ink is removed by wiping the nozzle surface multiple times with the sheet-like wiper 320 containing the cleaning fluid.

FIG. 4 is a schematic cross-sectional diagram illustrating the sheet-like wiper 320.

The sheet-like wiper 320 illustrated in FIG. 4 comprises a laminated body of nonwoven fabrics, which has a two-layer structure having, from the side which comes into contact with the nozzle surface, a first layer 610 and a second layer 620. Alternatively, the wiper may be in a three-layer structure in which the wiper is backed with a film for preventing the bleed-through of the absorbed ink and improving the strength of the wiper, or a multi-layer structure in which a plurality of absorption layers having different absorbabilities are provided after the second layer.

Preferably, the wiper is an ink absorbing member that includes at least two layers each having voids. Examples of the material constituting the layer having voids include woven fabrics, knitted fabrics, and porous bodies, in addition to nonwoven fabrics. In particular, for the first layer, nonwoven fabrics are preferred because it is relatively easily to control the thickness and void ratio thereof. Examples of the materials constituting fibers such as nonwoven fabrics, woven fabrics, and knitted fabrics include, but are not limited to, cotton, hemp, silk, pulp, nylon, vinylon, polyester, polypropylene, polyethylene, rayon, cupro, acrylic, and polylactic acid. The nonwoven fabric may be comprised of either one type of fiber or multiple types of fibers mixed. Examples of the porous bodies include, but are not limited to, polyurethane, polyolefin, and PVA. In producing nonwoven fabrics, web forming may be performed by wet, dry, spunbond, meltblown, or flash spinning methods, and web bonding may be performed by spunlace, thermal bond, chemical bond, or needle punch methods.

In the wiper according to an embodiment of the present invention, when the thickness t1 of the first layer that contacts the nozzle surface and the total thickness t2 of one or more of the layers other than the first layer satisfy the relation t1<t2 and the void ratio of the first layer is smaller than the void ratio of at least one of the layers other than the first layer, the ability for scraping off fixedly-adhered ink is improved and wiping property for removing fixedly-adhering ink is improved. Here, the void ratio is calculated as follows.

$$VOID RATIO = 1 - \frac{APPARENT DENSITY}{TRUE DENSITY} \qquad FORMULA ( 1 )$$

In a case in which the wiper comprises a sheet-like nonwoven fabric, the “true density” represents the true density of the fiber forming the sheet, and the “apparent density” is calculated by dividing the basis weight by the thickness of the sheet-like material.

The ability of the wiper for scraping off fixedly-adhered ink is improved as the thickness becomes small and the void ratio becomes small. However, when the thickness is small and the void ratio is small, it becomes difficult for the wiper to retain liquid components such as ink and cleaning fluid, and as a result, the cleaning property becomes insufficient with a single layer. For this reason, the effect of the present invention is exerted when a layer capable of retaining liquid components is provided other than the first layer and the layers of the wiper satisfy the above-described relations.

The void ratio of the first layer is preferably from 0.60 to 0.85, and more preferably from 0.75 to 0.80. When the void ratio of the first layer is from 0.60 to 0.85, wiping property for removing fixedly-adhered ink is improved, and the wiper is improved in liquid permeability without becoming a film-like shape.

The void ratio of at least one of the layers other than the first layer is preferably from 0.80 to 0.99. When the void ratio of at least one of the layers other than the first layer is within the above range, liquid absorbability is improved. As the first layer is combined with such a layer other than the first layer, both the ability for scraping off fixedly-adhered ink and the liquid absorbability are achieved at the same time, and thus wiping property is improved. Preferably, at least one of the layers other than the first layer which has a void ratio of from 0.80 to 0.99 or less is the second layer. Preferably, the void ratio of the first layer is smaller than the void ratio of the second layer.

For improving the effect of the present invention, the difference between the void ratio of the first layer and the void ratio of the second layer is preferably from 0.01 to 0.5, more preferably from 0.02 to 0.25.

The thickness of the wiper is preferably from 0.1 to 3 mm, more preferably from 0.2 to 0.7 mm. When the thickness of the wiper is 0.1 mm or more, the saturated water absorption amount for liquid per unit area of the wiper is sufficient to sufficiently absorb the ink to be wiped off. When the thickness of the wiper is 3 mm or less, the liquid component of the ink is suitably transferred from the first layer to one or more of the layers other than the first layer without impairing the liquid absorbability of the one or more of the layers other than the first layer, thus making it possible to downsize the apparatus.

Preferably, at least the first layer of the wiper is comprised of a nonwoven fabric. When the first layer of the wiper is made of a nonwoven fabric, the thickness and void ratio of the wiper can be easily set to within desired ranges.

In the wiper, the difference between the thickness of the first layer and the thickness of the second layer is preferably from 0.1 to 1 mm, more preferably from 0.19 to 0.5 mm.

### Ink

Compositional materials of the ink, i.e., organic solvents, resins, water, colorants, and additives, are described in detail below.

The ink according to an embodiment of the present invention contains an organic solvent in an amount of more than 60% by mass of the ink. By containing an organic solvent in an amount of more than 60% by weight of the ink, adhesiveness to recording media becomes high.

### Organic Solvent

There is no specific limitation on the type of the organic solvent. For example, water-soluble organic solvents can be used. Examples thereof include, but are not limited to, polyols, ethers such as polyol alkyl ethers and polyol aryl ethers, nitrogen-containing heterocyclic compounds, amides, amines, and sulfur-containing compounds.

Specific examples of the polyols include, but are not limited to, ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and 3-methyl-1,3,5-pentanetriol.

Specific examples of the polyol alkyl ethers include, but are not limited to, ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether.

Specific examples of the polyol aryl ethers include, but are not limited to, ethylene glycol monophenyl ether and ethylene glycol monobenzyl ether.

Specific examples of the nitrogen-containing heterocyclic compounds include, but are not limited to, 2-pyrrolidone, N-methyl-2-pyrrolidone, N-hydroxyethyl-2-pyrrolidone, 1,3-dimethyl-2-imidazolidinone, ε-caprolactam, and γ-butyrolactone.

Specific examples of the amides include, but are not limited to, formamide, N-methylformamide, N,N-dimethylformamide, 3-methoxy-N,N-dimethylpropionamide, and 3-butoxy-N,N-dimethylpropionamide.

Specific examples of the amines include, but are not limited to, monoethanolamine, diethanolamine, and triethylamine.

Specific examples of the sulfur-containing compounds include, but are not limited to, dimethylsulfoxide, sulfolane, and thiodiethanol.

Specific examples of other organic solvents include, but are not limited to, propylene carbonate and ethylene carbonate.

In particular, organic solvents having a boiling point of 250 degrees C. or less are preferable, since they not only function as wetting agents but also provide good drying property.

Preferred examples of organic solvents further include polyol compounds having 8 or more carbon atoms and glycol ether compounds. Specific examples of the polyol compounds having 8 or more carbon atoms include, but are not limited to, 2-ethyl-1,3-hexanediol and 2,2,4-trimethyl-1,3-pentanediol.

Specific examples of the glycol ether compounds include, but are not limited to, polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; and polyol aryl ethers such as ethylene glycol monophenyl ether and ethylene glycol monobenzyl ether.

As the type of the organic solvent, glycol ether compounds are preferred for the ink permeability of substrates and for the cleaning property of the wiper.

The proportion of the organic solvent in the ink is more than 60% by mass for fixability and drying property of the ink, preferably 70% by mass or more, and more preferably 80% by mass or more. Further, for permeability of media and accompanying fixing and drying properties, the organic solvent preferably contains an organic solvent having a solubility parameter of 26.0 or less.

Specific examples of the organic solvent having a solubility parameter of 26.0 or less include, but are not limited to, diethylene glycol methyl ethyl ether (solubility parameter: 17.6) and dipropylene glycol monomethyl ether (solubility parameter: 20.0).

The proportion of the organic solvent having a solubility parameter of 26.0 or less in the total organic solvent contained in the ink is preferably from 70% to 100% by mass, more preferably from 90% to 100% by mass.

### Resin

The type of the resin contained in the ink is not particularly limited and can be suitably selected to suit to a particular application. Specific examples thereof include, but are not limited to, polyurethane resins, polyester resins, acrylic resins, vinyl acetate resins, styrene resins, butadiene resins, styrene-butadiene resins, vinyl chloride resins, acrylic styrene resins, and acrylic silicone resins.

Resin particles made of these resins may also be used. The resin particles may be dispersed in water as a dispersion medium to prepare a resin emulsion. The ink can be obtained by mixing the resin emulsion with other materials such as a colorant and an organic solvent. These resin particles are available either synthetically or commercially. The resin particles may include one type or two or more types of resin particles.

For ink fixability, the proportion of the resin in the ink is preferably 6% by mass or less. When the proportion of the resin is 6% by mass or less, the coating film of the ink provides good drying property and fixability.

As the type of the resin contained in the ink, polyurethane resins are preferred.

Polyurethane resin is a reaction product of a polyisocyanate with a polyol. The polyurethane resin exerts performances of both a soft segment consisting of the polyol components having a weak cohesive force and a hard segment consisting of urethane bonds having a strong cohesive force. The soft segment is flexible and resistant to deformation of substrates, such as drawing and bending. The hard segment has excellent adhesiveness to substrates and high abrasion resistance.

Specific examples of the polyurethane resin include, but are not limited to, polyether urethane resins, polyester urethane resins, and polycarbonate urethane resins.

The type of polyurethane resin particles contained in the ink is not particularly limited and can be suitably selected to suit to a particular application.

The volume average particle diameter of the resin particles is not particularly limited and can be suitably selected to suit to a particular application, but is preferably from 10 to 1,000 nm, more preferably from 10 to 200 nm, and particularly preferably from 10 to 100 nm, for good fixability and high image hardness.

The volume average particle diameter can be measured with a particle size analyzer (NANOTRAC WAVE-UT151 available from MicrotracBEL Corp.).

### Water

The proportion of water in the ink is not particularly limited and can be suitably selected to suit to a particular application, but is preferably from 10% by mass or less for drying property and discharge reliability of the ink.

### Colorant

The colorant is not particularly limited, and pigments and dyes can be used as the colorant.

Usable pigments include both inorganic pigments and organic pigments. Each of these can be used alone or in combination with others. Mixed crystals can also be used as the pigments.

Usable pigments include black pigments, yellow pigments, magenta pigments, cyan pigments, white pigments, green pigments, orange pigments, glossy color pigments (e.g., gold pigments and silver pigments), and metallic pigments.

Specific examples of inorganic pigments include, but are not limited to, titanium oxide, iron oxide, calcium carbonate, barium sulfate, aluminum hydroxide, Barium Yellow, Cadmium Red, Chrome Yellow, and carbon black produced by a known method such as a contact method, a furnace method, and a thermal method.

Specific examples of organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, quinophthalone pigments), dye chelates (e.g., basic dye chelate, acid dye chelate), nitro pigments, nitroso pigments, and aniline black. Among these pigments, those having good affinity for solvents are preferred. In addition, hollow resin particles and hollow inorganic particles can also be used.

Specific examples of pigments used for black-and-white printing include, but are not limited to: carbon blacks (i.e., C.I. Pigment Black 7) such as furnace black, lamp black, acetylene black, and channel black; metals such as copper, iron (i.e., C.I. Pigment Black 11), and titanium oxide; and organic pigments such as aniline black (i.e., C.I. Pigment Black 1).

Specific examples of pigments used for color printing include, but are not limited to: C.I. Pigment Yellow 1, 3, 12, 13, 14, 17, 24, 34, 35, 37, 42 (Yellow Iron Oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (Red Iron Oxide), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4 (Phthalocyanine Blue), 16, 17:1, 56, 60, and 63; and C.I. Pigment Green 1, 4, 7, 8, 10, 17, 18, and 36.

The dyes are not particularly limited, and acid dyes, direct dyes, reactive dyes, and basic dyes can be used. Each of these can be used alone or in combination with others.

Specific examples of the dyes include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the colorant in the ink is preferably 15% by mass or less for good fixability and discharge stability, and more preferably 10% by mass or less. An ink containing 0% by mass of colorant, i.e., a clear ink containing no colorant, can also be used.

The pigment can be dispersed in the ink by any of the following methods: introducing a hydrophilic functional group to the pigment to make the pigment self-dispersible; covering the surface of the pigment with a resin; and dispersing the pigment by a dispersant.

In the method of introducing a hydrophilic functional group to the pigment to make the pigment self-dispersible, for example, a functional group such as sulfone group and carboxyl group may be introduced to the pigment (e.g., carbon) to make the pigment dispersible in water.

In the method of covering the surface of the pigment with a resin, for example, the pigment may be incorporated in a microcapsule to make the pigment self-dispersible in water. This pigment may be referred to as a resin-covered pigment. In this case, not all the pigment particles included in the ink should be covered with a resin. It is possible that a part of the pigment particles is not covered with any resin or partially covered with a resin.

In the method of dispersing the pigment by a dispersant, low-molecular dispersants and high-molecular dispersants, represented by known surfactants, may be used.

More specifically, any of anionic surfactants, cationic surfactants, ampholytic surfactants, and nonionic surfactants may be used as the dispersant depending on the property of the pigment.

For example, a nonionic surfactant RT-100 (available from Takemoto Oil & Fat Co., Ltd.) and sodium naphthalenesulfonate formalin condensate are preferably used as the dispersant.

Each of the above dispersants may be used alone or in combination with others.

### Pigment Dispersion

The ink can be obtained by mixing a pigment with other materials such as water and an organic solvent. The ink can also be obtained by, first, preparing a pigment dispersion by mixing a pigment with water, a dispersant, etc., and thereafter mixing the pigment dispersion with other materials such as water and an organic solvent.

The pigment dispersion can be obtained by mixing water, a pigment, a pigment dispersant, and other components, if any, to disperse the pigment, and adjusting the particle diameter of the pigment. Preferably, the dispersing is performed by a disperser.

The particle diameter of the pigment dispersed in the pigment dispersion is not particularly limited, but the number-based maximum frequency particle diameter is preferably in the range of from 20 to 500 nm, more preferably from 20 to 150 nm, for improving dispersion stability of the pigment and discharge stability and image quality (e.g., image density) of the ink. The particle diameter of the pigment can be measured with a particle size analyzer (NANOTRAC WAVE-UT151 available from MicrotracBEL Corp.).

The proportion of the pigment in the pigment dispersion is not particularly limited and can be suitably selected to suit to a particular application, but is preferably from 0.1% to 50% by mass, more preferably from 0.1% to 30% by mass, for improving discharge stability and enhancing image density.

Preferably, the pigment dispersion is subjected to filtration using a filter or a centrifugal separator to remove coarse particles, followed by degassing.

The particle size of solid contents in the ink is not particularly limited and can be suitably selected to suit to a particular application. The number-based maximum frequency particle diameter of solid contents in the ink is preferably in the range of from 20 to 1,000 nm, more preferably from 20 to 150 nm, for improving discharge stability and image quality (e.g., image density). The solid contents include the resin particles and pigment particles. The particle diameter can be measured with a particle size analyzer (NANOTRAC WAVE-UT151 available from MicrotracBEL Corp.).

### Additive

The ink may further contain a surfactant, a defoamer, a preservative, a fungicide, a corrosion inhibitor, and/or a pH adjuster.

### Surfactant

Usable surfactants include silicone-based surfactants, fluorine-based surfactants, ampholytic surfactants, nonionic surfactants, and anionic surfactants.

The silicone-based surfactants are not particularly limited and can be suitably selected to suit to a particular application. In particular, those that do not decompose even at a high pH are preferred. Specific examples of the silicone-based surfactants include, but are not limited to, side-chain-modified polydimethylsiloxane, both-end-modified polydimethylsiloxane, one-end-modified polydimethylsiloxane, and side-chain-and-both-end-modified polydimethylsiloxane. In particular, those having a polyoxyethylene group and/or a polyoxyethylene polyoxypropylene group as the modifying group are preferred because they demonstrate good characteristics as an aqueous surfactant. Specific examples of the silicone-based surfactants further include polyether-modified silicone-based surfactants, such as a dimethyl siloxane compound having a polyalkylene oxide structure on a side chain which is bound to Si.

Specific preferred examples of the fluorine-based surfactants include, but are not limited to, perfluoroalkyl sulfonic acid compounds, perfluoroalkyl carboxylic acid compounds, perfluoroalkyl phosphate compounds, perfluoroalkyl ethylene oxide adducts, and polyoxyalkylene ether polymer compounds having a perfluoroalkyl ether group on a side chain, each of which has weak foaming property. Specific examples of the perfluoroalkyl sulfonic acid compounds include, but are not limited to, perfluoroalkyl sulfonic acid and perfluoroalkyl sulfonate. Specific examples of the perfluoroalkyl carboxylic acid compounds include, but are not limited to, perfluoroalkyl carboxylic acid and perfluoroalkyl carboxylate. Specific examples of the polyoxyalkylene ether polymer compounds having a perfluoroalkyl ether group on a side chain include, but are not limited to, a sulfate of a polyoxyalkylene ether polymer having a perfluoroalkyl ether group on a side chain, and a salt of a polyoxyalkylene ether polymer having a perfluoroalkyl ether group on a side chain. Specific examples of the counter ions for these fluorine-based surfactants include, but are not limited to, Li, Na, K, NH₄, NH₃CH₂CH₂OH, NH₂(CH₂CH₂OH)₂, and NH(CH₂CH₂OH)₃.

Specific examples of the ampholytic surfactants include, but are not limited to, laurylaminopropionate, lauryl dimethyl betaine, stearyl dimethyl betaine, and lauryl hydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan fatty acid esters, polyoxyethylene sorbitan fatty acid esters, and ethylene oxide adducts of acetylene alcohol.

Specific examples of the anionic surfactants include, but are not limited to, acetate, dodecylbenzene sulfonate, and laurate of polyoxyethylene alkyl ether, and polyoxyethylene alkyl ether sulfate.

Each of these surfactants can be used alone or in combination with others.

The silicone-based surfactants are not particularly limited and can be suitably selected to suit to a particular application. Specific examples thereof include, but are not limited to, side-chain-modified polydimethylsiloxane, both-end-modified polydimethylsiloxane, one-end-modified polydimethylsiloxane, and side-chain-and-both-end-modified polydimethylsiloxane. More specifically, polyether-modified silicone-based surfactants having polyoxyethylene group and/or polyoxyethylene polyoxypropylene group as the modifying groups are preferred since they demonstrate good characteristics as an aqueous surfactant.

These surfactants are available either synthetically or commercially. Commercial products are readily available from, for example, BYK Japan KK, Shin-Etsu Chemical Co., Ltd., Dow Corning Toray Co., Ltd., Nihon Emulsion Co., Ltd., and Kyoeisha Chemical Co., Ltd.

The polyether-modified silicone-based surfactants are not particularly limited and can be suitably selected to suit to a particular application. Specific examples of commercially-available products of the polyether-modified silicone-based surfactants include, but are not limited to: KF-618, KF-642, and KF-643 (available from Shin-Etsu Chemical Co., Ltd.); EMALEX-SS-5602 and SS-1906EX (available from Nihon Emulsion Co., Ltd.); FZ-2105, FZ-2118, FZ-2154, FZ-2161, FZ-2162, FZ-2163, and FZ-2164 (available from Dow Corning Toray Co., Ltd); BYK-33 and BYK-387 (available from BYK Japan KK); and TSF4440, TSF4452, and TSF4453 (available from Momentive Performance Materials Inc.).

Preferably, the fluorine-based surfactant is a compound having 2 to 16 fluorine-substituted carbon atoms, more preferably a compound having 4 to 16 fluorine-substituted carbon atoms.

Specific examples of the fluorine-based surfactants include, but are not limited to, perfluoroalkyl phosphate compounds, perfluoroalkyl ethylene oxide adducts, and polyoxyalkylene ether polymer compounds having a perfluoroalkyl ether group on a side chain.

Among these, polyoxyalkylene ether polymer compounds having a perfluoroalkyl ether group on a side chain are preferred for their small foaming property.

The fluorine-based surfactants are available either synthetically or commercially. Specific examples of commercially-available fluorine-based surfactants include, but are not limited to: SURFLON S-111, S-112, S-113, S-121, S-131, S-132, S-141, and S-145 (available from Asahi Glass Co., Ltd.); Fluorad™ FC-93, FC-95, FC-98, FC-129, FC-135, FC-170C, FC-430, and FC-431 (available from 3M Japan Limited; MEGAFACE F-470, F-1405, and F-474 (available from DIC Corporation); Zonyl® TBS, FSP, FSA, FSN-100, FSN, FSO-100, FSO, FS-300, UR, CAPSTONE FS-30, FS-31, FS-3100, FS-34, and FS-35 (available from The Chemours Company); FT-110, FT-250, FT-251, FT-400S, FT-150, and FT-400SW (available from NEOS COMPANY LIMITED); PolyFox PF-136A, PF-156A, PF-151N, PF-154, and PF-159 (available from OMNOVA Solutions Inc.); and UNIDYNE™ DSN-403N (available from Daikin Industries, Ltd.). Among these, for improving printing quality, in particular color developing property, paper permeability, paper wettability, and uniform dying property, FS-3100, FS-34, and FS-300 (available from The Chemours Company), FT-110, FT-250, FT-251, FT-400S, FT-150, and FT-400SW (available from NEOS COMPANY LIMITED), PolyFox PF-151N (available from OMNOVA Solutions Inc.), and UNIDYNE™ DSN-403N (available from Daikin Industries, Ltd.) are particularly preferred.

The proportion of the surfactant in the ink is not particularly limited and can be suitably selected to suit to a particular application, but is preferably from 0.001% to 5% by mass, more preferably from 0.05% to 5% by mass, for improving wettability and discharge stability and enhancing image quality.

### Defoamer

Specific examples of the defoamer include, but are not limited to, silicone-based defoamers, polyether-based defoamers, and fatty-acid-ester-based defoamers. Each of these surfactants can be used alone or in combination with others. Among these defoamers, silicone-based defoamers are preferable since they have excellent defoaming ability.

### Preservative and Fungicide

Specific examples of the preservative and fungicide include, but are not limited to, 1,2-benzisothiazoline-3-one.

### Corrosion Inhibitor

Specific examples of the corrosion inhibitor include, but are not limited to, acid sulphite and sodium thiosulfate.

### pH Adjuster

The pH adjuster is not particularly limited as long as it is capable of adjusting the pH to 7 or higher. Specific examples thereof include, but are not limited to, amines such as diethanolamine and triethanolamine.

The properties of the ink are not particularly limited and can be suitably selected to suit to a particular application. As an example, preferred viscosity, surface tension, and pH of the ink are described below.

Preferably, the viscosity of the ink at 25 degrees C. is from 5 to 30 mPa·s, more preferably from 5 to 25 mPa·s, for improving print density and text quality and enhancing dischargeability. The viscosity can be measured at 25 degrees C. by a rotatory viscometer (RE-80L available from Toki Sangyo Co., Ltd.) equipped with a standard cone rotor (1° 34′×R24), while setting the sample liquid amount to 1.2 mL, the number of rotations to 50 rotations per minute (rpm), and the measuring time to 3 minutes.

Preferably, the surface tension of the ink is 35 mN/m or less, more preferably 32 mN/m or less, at 25 degrees C., so that the ink is suitably levelized on a recording medium and the drying time of the ink is shortened.

Preferably, the pH of the ink is from 7 to 12, more preferably from 8 to 11, for preventing corrosion of metal materials contacting the ink.

The recording apparatus may further optionally include, in addition to an ink discharge head, a pretreatment device and/or an aftertreatment device.

As an example, the pretreatment device and the aftertreatment device may be provided as a liquid discharger including a liquid container containing the pretreatment or aftertreatment liquid and a liquid discharge head to discharge the pretreatment or aftertreatment liquid by inkjet recording method, having a similar configuration to the liquid discharger for each of the black (K), cyan (C), magenta (M), and yellow (Y) inks.

As another example, the pretreatment device and the aftertreatment device may be provided as a device employing a method other than inkjet recording method, such as blade coating, roll coating, and spray coating.

### Pretreatment Liquid

The pretreatment liquid contains an agglomeration agent, an organic solvent, and water, and may further contain a surfactant, a defoamer, a pH adjuster, a preservative, a fungicide, and/or a corrosion inhibitor, as necessary.

Examples of the organic solvent, surfactant, defoamer, pH adjuster, preservative, fungicide, and corrosion inhibitor include the same materials as those used for the ink and known materials used for treatment liquids.

The agglomeration agent is not particularly limited. Examples thereof include, but are not limited to, water-soluble cationic polymers, acids, and polyvalent metal salts.

### Aftertreatment Liquid

The aftertreatment liquid is not particularly limited as long as it is capable of forming a transparent layer. The aftertreatment liquid may be prepared by mixing an organic solvent, water, a resin, a surfactant, a defoamer, a pH adjuster, a preservative, a fungicide, and/or a corrosion inhibitor, selected according to the need. The aftertreatment liquid can be applied to the entire recording area on a recording medium or only the printed area where an ink image has been formed.

### Recording Medium

The recording medium is not particularly limited. For example, plain paper, gloss paper, special paper, and cloth can be used. Also, impermeable substrates can be used to form good quality images.

The impermeable substrate refers to a substrate having a surface with a low level of moisture permeability and absorptivity. Examples thereof include a material having a number of hollow spaces inside but not open to the exterior. To be more quantitative, the impermeable substrate refers to a substrate that absorbs water in an amount of 10 mL/m² or less in a time period from the start of contact to 30 msec^{1/2} after the start of contact, when measured according to the Bristow method.

Specific preferred examples of the impermeable substrate include, but are not limited to, plastic films such as vinyl chloride resin films, polyethylene terephthalate (PET) films, polypropylene films, polyethylene films, and polycarbonate films.

The recording medium is not limited to articles used as typical recording media. Examples of articles usable as the recording medium include: building materials such as wall paper, floor material, and tile; cloth for apparel such as T-shirt; textile; and leather. In addition, by adjusting the configuration of paths through which the recording medium is conveyed, ceramics, glass, and metals may be used as the recording medium.

### Recorded Matter

A recorded matter according to an embodiment of the present invention includes a recording medium and an image formed with the ink according to an embodiment of the present invention on the recording medium.

The recorded matter may be manufactured by an inkjet recording device and an inkjet recording method.

The applications of the ink according to an embodiment of the present invention are not particularly limited. For example, the ink can be used for printed matter, paints, coating materials, and foundations. Furthermore, the ink can be used not only to form two-dimensional texts and images but also as a material for forming three-dimensional images (i.e., three-dimensional objects).

A three-dimensional object forming apparatuses for forming a three-dimensional object is not particularly limited and well-known apparatuses may be used, such as those equipped with a container, a supplier, a discharger, and a dryer of the ink. The three-dimensional object includes an object produced by re-applying ink over and over. In addition, the three-dimensional object includes a processed product produced by processing a structure including a substrate (such as a recording medium) and an ink applied thereon. The processed product may be produced by subjecting a sheet-like or film-like recorded matter or structural body to a molding processing such as heat stretching processing and punching processing. The processed product is suitably applied to those formed after surface decoration, such as meters and operation panels of automobiles, office automation equipment, electric or electronic devices, and cameras.

In the present disclosure, “image forming”, “recording”, and “printing” are treated as synonymous terms.

In addition, “recording media”, “media”, and “print media” are synonyms.

### EXAMPLES

Further understanding of the present disclosure can be obtained by reference to certain specific Examples and Comparative Examples provided herein below for the purpose of illustration only and are not intended to be limiting.

In Examples and Comparative Examples, the inks were prepared and evaluated under a room temperature of 25 degrees C. and a humidity of 60%, unless otherwise specified.

### Preparation of Inks

### Preparation of Pigment Dispersion

The below-listed materials were premixed. The resulting mixture was subject to a circulation dispersion treatment using a disk-type bead mill (KDL available from Shinmaru Enterprises Corporation, filled with zirconia ball media having a diameter of 0.3 mm) for 7 hours. Thus, a cyan pigment dispersion liquid was prepared.
Pigment Blue 15:4: 15% by mass
Anionic surfactant: 2% by mass
Ion-exchange water: 83% by mass

### Preparation of Urethane Resin Emulsion

In a reaction vessel into which a stirrer, a reflux condenser, and a thermometer were inserted, 1,500 g of a POLYLITE OD-X-2420 (available from DIC Corporation, polyester polyol), 220 g of 2,2-dimethylolpropionic acid (DMPA), and 1,347 g of N-methylpyrrolidone (NMP) were put under a nitrogen gas atmosphere and heated to 60 degrees C. to dissolve DMPA.

Further, 1,445 g of 4,4′-dicyclohexylmethane diisocyanate and 2.6 g of dibutyltin dilaurate (as a catalyst) were put in the vessel and heated to 90 degrees C. to conduct an urethane-forming reaction for 5 hours. Thus, an isocyanate-terminated urethane prepolymer was prepared.

The reaction mixture was cooled to 80 degrees C. and 149 g of triethylamine was mixed therein. The resulted mixture in an amount of 4,340 g was taken out and mixed in a mixed solution of 5,400 g of water and 15 g of triethylamine under a vigorous stirring. Next, 1,500 g of ice was put in the vessel, and 626 g of a 35% by mass aqueous solution of 2-methyl-1,5-pentanediamine was further put therein to conduct a chain extension reaction. The solvent was distilled so that the solid content became 30% by mass. The resulted resin emulsion was subjected to a dispersion treatment by a PAINT CONDITIONER (manufactured by Red Devil Equipment Co., the revolution adjustable within a range of from 50 to 1,425 rpm). Thus, a urethane resin emulsion having a solid content concentration of 40.0% by mass was prepared.

### Preparation of Acrylic Resin Emulsion

As an acrylic resin emulsion, VONCOAT CF-6140 (available from DIC Corporation) was used.

### Ink Preparation Method

Each ink was prepared by stir-mixing materials according to the formulation shown in Table 1 (the unit of the numerical value is % by mass) and filtering the mixture with a 0.5-μm polypropylene filter. Solubility parameters of the organic solvents used in the Examples are as follows.

Ethylene glycol: 33.0

Diethylene glycol methyl ethyl ether: 17.6

Dipropylene glycol monomethyl ether: 20.0

γ-Butyrolactone: 25.6

TABLE 1

| | Ink | Ink | Ink | Ink | Ink | Ink | Ink |
|---|---|---|---|---|---|---|---|
| | Preparation | Preparation | Preparation | Preparation | Preparation | Preparation | Preparation |
| | Example 1 | Example 2 | Example 3 | Example 4 | Example 5 | Example 6 | Example 7 |
| Cyan Pigment | 3 | 3 | 3 | 3 | 3 | 3 | 3 |
| Dispersion | | | | | | | |
| (Solid Contents) | | | | | | | |
| Diethylene Glycol | 70 | 60 | 50 | 60 | | | 40 |
| Methyl Ethyl Ether | | | | | | | |
| Ethylene Glycol | | | | | 60 | 60 | |
| Dipropylene | 10 | 5 | 5 | 5 | 5 | | 5 |
| Glycol | | | | | | | |
| Monomethyl Ether | | | | | | | |
| γ-Butyrolactone | 10 | 5 | 6 | 5 | 5 | 10 | 5 |
| Urethane Resin | 6 | | | | | | |
| Emulsion | | | | | | | |
| (Solid Contents) | | | | | | | |
| Acrylic Resin | | 6 | 6 | 10 | 6 | 6 | 6 |
| Emulsion | | | | | | | |
| (Solid Contents) | | | | | | | |
| Ion-exchange | Balance | Balance | Balance | Balance | Balance | Balance | Balance |
| Water | | | | | | | |

### Examples 1 to 31 and Comparative Examples 1 to 5

Each of the above-prepared inks and each of the wipers shown in Table 2 were combined with an image forming apparatus equipped with a discharger having a nozzle surface, configured to discharge an ink from the nozzle, and a wiper configured to wipe the nozzle surface of the discharger, and the following evaluations were performed. Each of the wipers shown in Table 2 was a sheet-like laminated body including at least two layers each having voids. The first layer and the second layer were both made of nonwoven fabrics.

### Evaluations

### Wiping Property

First, 0.1 ml of the above-prepared ink was dropped on a nozzle plate of an inkjet head (MH5440 manufactured by Ricoh Co., Ltd.), and the nozzle plate was left to stand for 15 hours. As a result, the nozzle plate with the fixedly-adhered ink was prepared.

After a cleaning fluid having the following composition was applied to the wiper shown in Table 2 at 20 μl/cm², the surface of the nozzle plate was wiped with the wiper. In the wiping operation, the pressing force was 3 N and the wiping speed was 50 mm/s.

Composition of Cleaning Fluid
3-Methoxy-3-methyl-1-butanol (available from Kuraray Co., Ltd): 20% by mass
Polyether-modified silicone surfactant (WET270 available from Evonik Japan Co., Ltd.): 1% by mass
Ion-exchange water: balance

### Evaluation Method

The nozzle plate was visually observed after the wiping operations, and the number of times of wiping operations performed until the fixedly-adhered ink had been removed was evaluated. In the following evaluation criteria, A, B, and C are acceptable for practical use, B is preferable, and A is more preferable.

### Evaluation Criteria

A: The wiping operation was performed 5 times until the fixedly-adhered ink on the nozzle plate had been removed.

B: The wiping operation was performed 7 times until the fixedly-adhered ink on the nozzle plate had been removed.

C: The wiping operation was performed 10 times until the fixedly-adhered ink on the nozzle plate had been removed.

D: The fixedly-adhered ink had remained even after performing the wiping operation 11 times.

### Adhesiveness

A solid image was formed with each of the inks shown in Table 1 on a PVC film as a recording medium. The solid image was subjected to a cross-cut adhesion test using a fabric adhesive tape (123LW-50 available from Nichiban Co., Ltd.), and the remaining number of squares out of the 100 squares was counted to evaluate adhesiveness to the recording medium in accordance with the following evaluation criteria. In the following evaluation criteria, A, B, and C are acceptable for practical use, B is preferable, and A is more preferable.

Evaluation Criteria

A: The number of remaining squares was 98 or more.

B: The number of remaining squares was 90 or more and less than 98.

C: The number of remaining squares was 70 or more and less than 90.

D: The number of remaining squares was less than 70.

The results are shown in Table 2.

TABLE 2

| | | | | Thickness (mm) | | Void Ratio | | Results | |
|---|---|---|---|---|---|---|---|---|---|
| | | Used Fiber | | 1st | 2nd | 1st | 2nd | | Wiping |
| | Ink | 1st Layer | 2nd Layer | Layer | Layer | Layer | Layer | Adhesiveness | Property |
| Ex. 1 | Preparation | Polyester | Rayon | 0.06 | 0.25 | 0.80 | 0.82 | A | A |
| | Example 1 | | | | | | | | |
| Ex. 2 | Preparation | Polyester | Rayon | 0.06 | 0.25 | 0.80 | 0.82 | A | A |
| | Example 2 | | | | | | | | |
| Ex. 3 | Preparation | Polyester | Rayon | 0.06 | 0.25 | 0.80 | 0.82 | A | A |
| | Example 3 | | | | | | | | |
| Ex. 4 | Preparation | Polyester | Rayon | 0.06 | 0.25 | 0.80 | 0.82 | B | B |
| | Example 4 | | | | | | | | |
| Ex. 5 | Preparation | Polyester | Rayon | 0.06 | 0.25 | 0.80 | 0.82 | C | A |
| | Example 5 | | | | | | | | |
| Ex. 6 | Preparation | Polyester | Rayon | 0.06 | 0.25 | 0.80 | 0.82 | C | A |
| | Example 6 | | | | | | | | |
| Ex. 7 | Preparation | Polyester | Rayon | 0.06 | 0.25 | 0.58 | 0.80 | A | C |
| | Example 1 | | | | | | | | |
| Ex. 8 | Preparation | Polyester | Rayon | 0.06 | 0.25 | 0.60 | 0.80 | A | B |
| | Example 1 | | | | | | | | |
| Ex. 9 | Preparation | Polyester | Rayon | 0.06 | 0.25 | 0.74 | 0.80 | A | B |
| | Example 1 | | | | | | | | |
| Ex. 10 | Preparation | Polyester | Rayon | 0.06 | 0.25 | 0.75 | 0.80 | A | A |
| | Example 1 | | | | | | | | |
| Ex. 11 | Preparation | Polyester | Rayon | 0.06 | 0.25 | 0.81 | 0.82 | A | B |
| | Example 1 | | | | | | | | |
| Ex. 12 | Preparation | Polyester | Rayon | 0.06 | 0.25 | 0.85 | 0.87 | A | B |
| | Example 1 | | | | | | | | |
| Ex. 13 | Preparation | Polyester | Rayon | 0.06 | 0.25 | 0.88 | 0.90 | A | C |
| | Example 1 | | | | | | | | |
| Ex. 14 | Preparation | Polyester | Rayon | 0.06 | 0.25 | 0.58 | 0.99 | A | C |
| | Example 1 | | | | | | | | |
| Ex. 15 | Preparation | Polyester | Rayon | 0.06 | 0.25 | 0.60 | 0.99 | A | B |
| | Example 1 | | | | | | | | |
| Ex. 16 | Preparation | Polyester | Rayon | 0.06 | 0.25 | 0.74 | 0.99 | A | B |
| | Example 1 | | | | | | | | |
| Ex. 17 | Preparation | Polyester | Rayon | 0.06 | 0.25 | 0.75 | 0.99 | A | A |
| | Example 1 | | | | | | | | |
| Ex. 18 | Preparation | Polyester | Rayon | 0.06 | 0.25 | 0.80 | 0.99 | A | A |
| | Example 1 | | | | | | | | |
| Ex. 19 | Preparation | Polyester | Rayon | 0.06 | 0.25 | 0.81 | 0.99 | A | B |
| | Example 1 | | | | | | | | |
| Ex. 20 | Preparation | Polyester | Rayon | 0.06 | 0.25 | 0.85 | 0.99 | A | B |
| | Example 1 | | | | | | | | |
| Ex. 21 | Preparation | Polyester | Rayon | 0.06 | 0.25 | 0.88 | 0.99 | A | C |
| | Example 1 | | | | | | | | |
| Ex. 22 | Preparation | Polyester | Rayon | 0.06 | 0.25 | 0.60 | 0.78 | A | C |
| | Example 1 | | | | | | | | |
| Ex. 23 | Preparation | Polyester | Rayon | 0.06 | 0.25 | 0.74 | 0.78 | A | C |
| | Example 1 | | | | | | | | |
| Ex. 24 | Preparation | Polyester | Rayon | 0.06 | 0.25 | 0.75 | 0.78 | A | B |
| | Example 1 | | | | | | | | |
| Ex. 25 | Preparation | Polyester | Rayon | 0.06 | 0.25 | 0.77 | 0.88 | A | A |
| | Example 1 | | | | | | | | |
| Ex. 26 | Preparation | Polyester | Rayon | 0.12 | 0.50 | 0.75 | 0.80 | A | A |
| | Example 1 | | | | | | | | |
| Ex. 27 | Preparation | Polyester | Rayon | 0.05 | 0.10 | 0.75 | 0.80 | A | A |
| | Example 1 | | | | | | | | |
| Ex. 28 | Preparation | Polyolefin | Rayon + | 0.06 | 0.25 | 0.77 | 0.88 | A | A |
| | Example 1 | | Polyolefin | | | | | | |
| | | | (Mixing | | | | | | |
| | | | ratio 50:50) | | | | | | |
| Ex. 29 | Preparation | Polyester | Polyolefin | 0.06 | 0.25 | 0.77 | 0.88 | A | A |
| | Example 1 | | Porous Body | | | | | | |
| Ex. 30 | Preparation | Polyester | Rayon | 0.06 | 0.25 | 0.77 | 0.88 | A | A |
| | Example 1 | | (PET Film | | | | | | |
| | | | Backing) | | | | | | |
| Ex. 31 | Preparation | Polyester | Rayon | 0.06 | 0.1/ | 0.77 | 0.82/ | A | A |
| | Example 1 | | (2 layers) | | 0.12 | | 0.95 | | |
| Comp. Ex. 1 | Preparation | Polyester | Rayon | 0.06 | 0.25 | 0.80 | 0.82 | D | A |
| | Example 7 | | | | | | | | |
| Comp. Ex. 2 | Preparation | Polyester | Rayon | 0.06 | 0.25 | 0.85 | 0.81 | A | D |
| | Example 1 | | | | | | | | |
| Comp. Ex. 3 | Preparation | Polyester | Rayon | 0.30 | 0.10 | 0.78 | 0.92 | A | D |
| | Example 1 | | | | | | | | |
| Comp. Ex. 4 | Preparation | Polyester | Rayon | 0.12 | 0.50 | 0.85 | 0.81 | A | D |
| | Example 1 | | | | | | | | |
| Comp. Ex. 5 | Preparation | Polyester | Rayon | 0.12 | 0.05 | 0.85 | 0.81 | A | D |
| | Example 1 | | | | | | | | |

It is clear from the comparison between Examples and Comparative Example 1, when the proportion of the organic solvent in the ink is 60% by mass or less, the adhesiveness to the recording medium is poor.

It is clear from the comparison between Examples and Comparative Examples 4 to 5, when the void ratio of the first layer is larger than the void ratio of the second layer, the wiping property for removing the fixedly-adhered ink is poor.

It is clear from the comparison between Examples and Comparative Example 3, when the thickness of the first layer is larger than the total thickness of one or more of the layers other than the first layer, the wiping property for removing the fixedly-adhered ink is poor.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A printer comprising:
a discharger having a nozzle surface and containing an ink comprising an organic solvent in an amount of more than 60% by mass of the ink, the discharger configured to discharge the ink from the nozzle; and
a wiper configured to wipe the nozzle surface, the wiper comprising a laminated body including a plurality of layers including a first layer that contacts the nozzle surface,
wherein a thickness t1 of the first layer and a total thickness t2 of one or more of the layers other than the first layer satisfy the following relation t1<t2,
wherein the first layer has a void ratio smaller than a void ratio of at least one of the layers other than the first layer.

2. The printer according to claim 1, wherein the first layer has a void ratio of from 0.6 to 0.85.

3. The printer according to claim 2, wherein the first layer has a void ratio of from 0.75 to 0.80.

4. The printer according to claim 1, wherein at least one of the layers other than the first layer has a void ratio of from 0.80 to 0.99.

5. The printer according to claim 1, wherein the first layer comprises a nonwoven fabric.

6. The printer according to claim 1, wherein the wiper has a thickness of from 0.1 to 3 mm.

7. The printer according to claim 1, wherein the ink further comprises a resin in an amount of 6% by mass or less of the ink.

8. The printer according to claim 1, wherein the organic solvent comprises glycol ether.

9. The printer according to claim 1, wherein the organic solvent has a solubility parameter of 26.0 or less.

10. The printer according to claim 1, wherein the ink further comprises a colorant and water.
